(19) United States
(12) Patent Application Publication
(10) Pub. No.: US 2011/0042386 A1
(43) Pub. Date: Feb. 24, 2011

(54) PRESSURE VESSEL FOR PROPELLANTS, EXPLOSION PREVENTING METHOD OF THE SAME, AND MANUFACTURING METHOD OF THE SAME

(75) Inventors: Byeong-Yeol Park, Daejeon (KR); Yung-Ju Yun, Daejeon (KR); Sang-Ki Chung, Daejeon (KR)

Correspondence Address: Vierra Magen Marcus & DeNiro LLP, 575 Market Street, Suite 2500, San Francisco, CA, 94105, US

(73) Assignee: AGENCY FOR DEFENSE DEVELOPMENT, Daejeon (KR)

(21) Appl. No.: 12/690,661

(22) Filed: Jan. 20, 2010

(30) Foreign Application Priority Data
Aug. 20, 2009 (KR) 10-2009-0077276

(51) Int. Cl. F02K 9/60; F17C 1/06; B29C 70/32; B64G 1/40

(52) U.S. Cl. 220/589; 239/265.11; 239/302; 60/200.1; 156/195; 60/204

(57) ABSTRACT

A pressure vessel for propellants, an explosion preventing method of the same, and a manufacturing method of the same are disclosed. The pressure vessel for propellants comprises a body provided with a cylindrical portion between a forward dome and an aft dome, and has an inner space where propellants are arranged. The pressure vessel also includes an insulation layer disposed on an inner wall of the body and configured to insulate the body from the inner space when the propellants are ignited; and a nozzle mounted at the aft dome and through which combustion material from the propellants is exhausted out. The body comprises a first hybrid fiber layer which forms the cylindrical portion, the forward dome, and the aft dome, and has a mechanical property lowered at a temperature more than a specific temperature such that the forward dome and the aft dome collapse by an inner pressure when the propellants are abnormally combusted. The body further comprises a second hybrid fiber layer which forms at least a part of the cylindrical portion, and maintains its mechanical property when the propellants are abnormally combusted.

### CROSS-REFERENCE TO A RELATED APPLICATION

Pursuant to 35 U.S.C. §119(a), this application claims the benefit of earlier filing date and right of priority to Korean Application No. 10-2009-000077276, filed on Aug. 20, 2009, the contents of which is incorporated by reference herein in its entirety.

### BACKGROUND OF THE INVENTION

1. Field of Invention

The present invention relates to a pressure vessel for propellants formed of hybrid fibers, an explosion preventing method of the same, and a manufacturing method of the same.

2. Background of the Invention

Generally, propellants for rockets, missiles, etc. are arranged inside a pressure vessel. The pressure vessel is manufactured by a filament winding process using composite material. The pressure vessel formed of composite material has a high structural function.

Under normal circumstances, the propellants are ignited by an igniter. As combustion material from the propellants is exhausted to a nozzle when the propellants are ignited, thrust occurs. Each of the propellants has its own ignition temperature where ignition starts. Most of the propellants have ignition temperatures much higher than an operation temperature and a storage temperature of the missiles.

When these propellants are treated improperly, severe situations may occur. For instance, the propellants are ignited by external flame at a wrong time or place, the missile may explode or have an uncontrollable thrust. Since it is impossible to stop the ignition of the propellants, the improperly ignited propellants may cause personal injury and physical damages.

In order to solve these problems, have been performed various efforts to deposit an insulation material on an outer surface of the pressure vessel. However, depositing an insulation material on an outer surface of the pressure vessel merely serves to delay the time taken for external flame to reach the propellants a little. Accordingly, when the external flame is not extinguished within a short time, the propellants are ignited to cause explosion of the rocket.

Therefore, have been required a new structure of the pressure vessel capable of solving the problems that may occur as the propellants are abnormally combusted.

### SUMMARY OF THE INVENTION

Therefore, an object of the present invention is to provide a structure capable of preventing explosion or an uncontrollable state of a pressure vessel due to abnormal combustion of propellants, an explosion preventing method of the same, and a manufacturing method of the same.

To achieve these and other advantages and in accordance with the purpose of the present invention, as embodied and broadly described herein, there is provided a pressure vessel for propellants, comprising: a body provided with a cylindrical portion between a forward dome and an aft dome, and having an inner space where propellants are arranged; an insulation layer disposed on an inner wall of the body, and configured to insulate the body from the inner space when the propellants are ignited; and a nozzle mounted at the aft dome, and through which combustion material from the propellants is exhausted out, wherein the body comprises: a first hybrid fiber layer which forms the cylindrical portion, the forward dome, and the aft dome, and having a mechanical property lowered at a temperature more than a specific temperature such that the forward dome and the aft dome collapse by an inner pressure when the propellants are abnormally combusted; and a second hybrid fiber layer which forms at least a part of the cylindrical portion, and maintaining its mechanical property when the propellants are abnormally combusted.

The first hybrid fiber layer may be formed by mixing dynamic fiber and epoxy resin with each other. And, the dynamic fiber may have a mechanical property lower than that at room temperature, in the range from a temperature more than a highest storage temperature of the propellants to a temperature lower than an ignition temperature.

The dynamic fiber may be formed of material which melts at a temperature lower than the ignition temperature of the propellants. The material may be provided with a chemical structure of polyolefin having a uni-directional structure.

The second hybrid fiber layer may be formed by mixing stable fiber and epoxy resin with each other. At a temperature more than the ignition temperature of the propellants, the stable fiber may have a mechanical property equal to that at room temperature.

To achieve these and other advantages and in accordance with the purpose of the present invention, as embodied and broadly described herein, there is also provided a method for preventing explosion of a pressure vessel for propellants comprising: a body provided with a cylindrical portion between a forward dome and an aft dome; propellants arranged at an inner space of the body; an insulation layer disposed on an inner wall of the body, and configured to insulate the body from the inner space when the propellants are ignited; and a nozzle mounted at the aft dome, and through which combustion material from the propellants is exhausted out, the method comprising: lowering mechanical properties of the forward dome and the aft dome by an external temperature of the body such that the propellants are abnormally combusted, the external temperature increased to a temperature more than a predetermined temperature; and collapsing the forward dome and the aft dome according to increase of an inner pressure of the body due to the combustion of the propellants.

To achieve these and other advantages and in accordance with the purpose of the present invention, as embodied and broadly described herein, there is still also provided a method for manufacturing a pressure vessel for propellants, the pressure vessel having a cylindrical portion between a forward dome and an aft dome, the method comprising: forming the forward dome, the cylindrical portion, and the aft dome by winding dynamic fiber impregnated with epoxy resin; forming a part of the cylindrical portion by winding stable fiber impregnated with epoxy resin while the dynamic fiber is being wound or after the dynamic fiber has been wound; and curing the epoxy resin, wherein the dynamic fiber has a mechanical property lower than that at room temperature, in the range from a temperature more than a highest storage temperature of the propellants to a temperature lower than an ignition temperature of the propellants, and wherein at a temperature more than the ignition temperature of the propellants, the stable fiber has a mechanical property equal to that at room temperature.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a frontal view of a pressure vessel for propellants according to a first embodiment of the present invention;

FIG. 2 is a schematic sectional view of the pressure vessel of FIG. 1;

FIG. 3 is an enlarged sectional view of a body of FIG. 2; and

FIG. 4 is a sectional view of the pressure vessel, which shows that a forward dome and an aft dome have collapsed by abnormal combustion of propellants.

### DETAILED DESCRIPTION OF THE INVENTION

Description will now be given in detail of the present invention, with reference to the accompanying drawings.

Hereinafter, a pressure vessel for propellants formed of hybrid fibers, an explosion preventing method of the same, and a manufacturing method of the same according to the present invention will be explained in more detail with reference to the attached drawings.

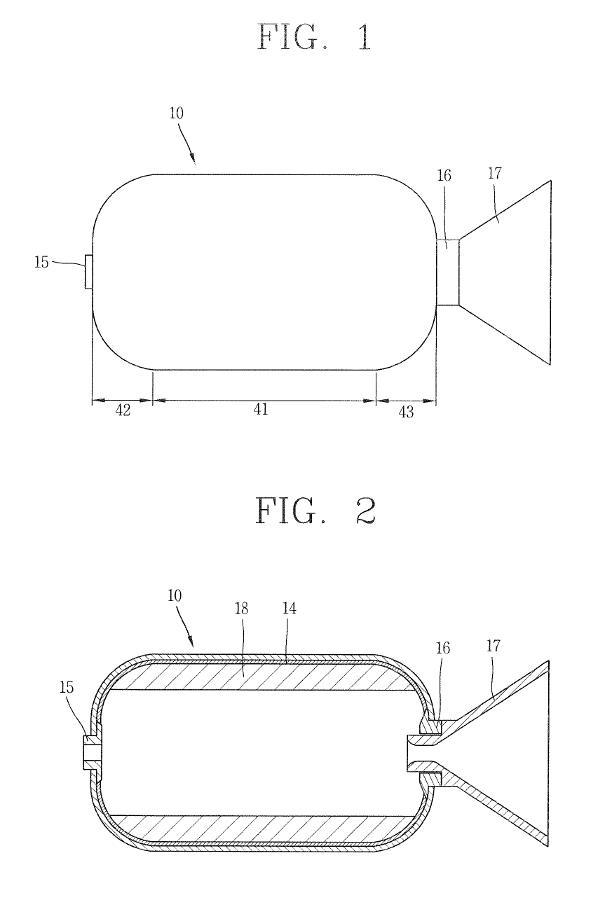

FIG. 1 is a frontal view of a pressure vessel for propellants according to a first embodiment of the present invention, and FIG. 2 is a schematic sectional view of the pressure vessel of FIG. 1.

Referring to FIG. 1, the pressure vessel for propellants comprises a body 10, an insulation layer 14, a nozzle 17, etc.

The body 10 constitutes the appearance of the pressure vessel, and is provided with an inner space for containing propellants 18. The body 10 includes a cylindrical portion 41 having a cylindrical shape, and a forward dome 42 and an aft dome 43 formed at both ends of the cylindrical portion 41.

The body 10 may be manufactured by a filament winding process using hybrid fiber, which will be later explained.

The propellants 18 are disposed at the inner space of the body 10. Each of the propellants 18 having a cavity may be arranged along an inner wall of the body 10.

The insulation layer 14 is formed on the inner wall of the body 10. That is, the insulation layer 14 is arranged between the body 10 and the propellant 18, and serves to insulate the body 10 from the inner space when the propellant 18 is ignited.

The nozzle 17 is mounted at the aft dome 43, and combustion material from the propellants 18 is exhausted out through the nozzle 17.

A forward boss 15 and an aft boss 16 each formed of a metallic material are mounted at the forward dome 42 and the aft dome 43, respectively. The forward boss 15 serves to connect an igniter to the body 10, and the aft boss 16 serves to connect the nozzle 17 to the body 10. The forward boss 15 and the aft boss 16 may be integrally manufactured with the body 10 by a filament winding process.

Once the propellants 18 are ignited by an igniter in a normal circumstance, combustion material from the propellants 18 is exhausted out through the nozzle 17. As a result, thrust is produced.

However, when an ambient temperature of the body 10 increases due to external fire, etc., the propellants 18 may be ignited. This may cause personal injury and physical damages.

Hereinafter, will be explained a structure of the body to solve problems that may occur when the propellants 18 are abnormally combusted.

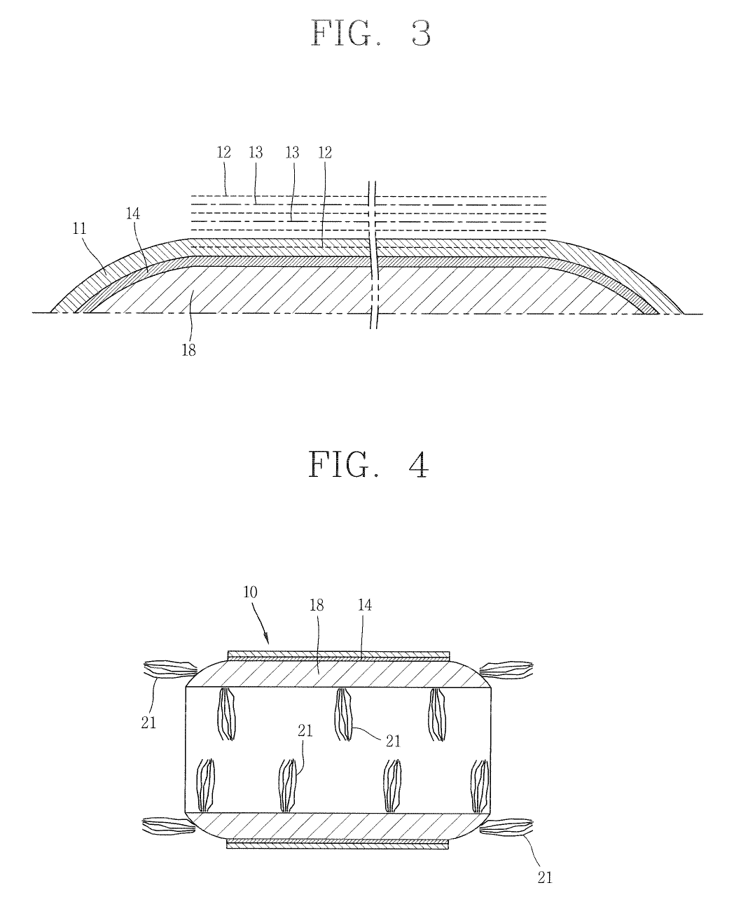

FIG. 3 is an enlarged sectional view of the body of FIG. 2.

The body 10 is manufactured by a filament winding process. The filament winding process indicates a process for winding fiber impregnated with a liquid resin on a surface of a mandrel to be manufactured, and then for curing the wound fiber.

Referring to FIG. 3, the body 10 includes a first hybrid fiber layer 11, and second hybrid fiber layers 12, 13.

The first hybrid fiber layer 11 forms the cylindrical portion 41, the forward dome 42, and the aft dome 43. And, the first hybrid fiber layer 11 is configured such that a mechanical property thereof is lowered at a temperature more than a specific temperature. This configuration is implemented in order to collapse the forward dome 42 and the aft dome 43 by an inner pressure when the propellants 18 are abnormally combusted.

The first hybrid fiber layer 11 is formed by mixing dynamic fiber and epoxy resin with each other. The first hybrid fiber layer 11 is formed by helically winding dynamic fiber impregnated with epoxy resin from the forward dome 42 (or aft dome 43) to the aft dome 43 (or forward dome 42) via the cylindrical portion 41. In the temperature range above a highest storage temperature of the propellants but below an ignition temperature of the propellants, the dynamic fiber has a mechanical property lower than that at room temperature.

For instance, in the case that the propellants 18 have a storage temperature range of −30°˜80°, a mechanical property of the dynamic fiber is drastically lowered in the temperature range between a temperature more than 80° and the ignition temperature of the propellants 18. The dynamic fiber may be configured such that the body 10 of the pressure vessel has a collapse pressure value less than 70% of a collapse pressure value at room temperature, at a temperature more than the highest storage temperature of the propellants 18 (e.g., 80°).

The dynamic fiber may be formed of a material that can melt at a temperature closer to the ignition temperature of the propellants 18, e.g., 145°.

For example, the dynamic fiber may be formed of polyolefin having a large molecular amount and a uni-directional structure. A chemical structure of the polyolefin may include polyethylene.

In the temperature range from a temperature more than the highest storage temperature of the propellants 18 to a temperature less than the ignition temperature of the propellants 18, the epoxy resin of the present invention does not melt, but has a lowered mechanical property.

The second hybrid fiber layers 12, 13 form at least one part of the cylindrical portion 41, and are formed of material capable of maintaining their mechanical properties when the propellants 18 are abnormally combusted.

As the ambient temperature increases to a temperature more than the highest storage temperature of the propellants 18, a mechanical property of the first hybrid fiber layer 11 is lowered, whereas mechanical properties of the second hybrid fiber layers 12, 13 are maintained. Accordingly, even in the case that the forward dome 42 and the aft dome 43 collapse by an inner pressure of the body 10, the shape of the cylindrical portion 41 can be maintained.

The second hybrid fiber layers 12, 13 are formed by mixing stable fiber and epoxy resin with each other.

Even at a temperature more than the ignition temperature of the propellants 18, the stable fiber has a mechanical property nearly equal to that at room temperature. That is, the mechanical property of the stable fiber is scarcely changed even when the propellants 18 are ignited.

The stable fiber may be formed of one of carbon, aramid, glass, and metal, or may be formed of hybrid fiber implemented as at least two of the materials are mixed to each other.

The epoxy resin has the same characteristic as the first hybrid fiber layer 11.

The second hybrid fiber layers may include a hoop winding 12 formed as stable fiber impregnated with epoxy resin is wound in a circumferential direction of the body 10, and an axial winding 13 formed as stable fiber impregnated with epoxy resin is wound in an axial direction of the body 10.

The helical winding of the first hybrid fiber layer 11, and the hoop winding 12 of the second hybrid fiber layers 12, 13 are alternately formed. And, the hoop winding 12 and the axial winding 13 are also alternately formed, thereby forming the body 10. The hoop winding 12 and the axial winding 13 are formed on a position corresponding to the cylindrical portion 41.

The helical winding of the first hybrid fiber layer 11, and the hoop winding 12 of the second hybrid fiber layers 12, 13 structurally support increase of an inner pressure of the body 10, the increase occurring as the propellants 18 are combusted. And, the axial winding 13 of the second hybrid fiber layers 12, 13 serves to endure transformation of the body 10 in an axial direction, the transformation occurring when a missile flies at a high speed.

Hereinafter, processes for manufacturing the body 10 will be explained.

Firstly, dynamic fiber impregnated with a liquid epoxy resin is stacked on the surface of a mandrel to be manufactured in a helical winding manner. The dynamic fiber impregnated with a liquid epoxy resin is helically wound on the mandrel from the forward dome 42 to the aft dome 43 via the cylindrical portion 41, thereby forming the first hybrid fiber layer 11. Here, the forward boss 15 and the aft boss 16 may be also integrally formed with the body 10 in a filament winding process.

While the dynamic fiber is being wound or has been wound on the mandrel, stable fiber impregnated with a liquid is wound on the mandrel, thereby forming the second hybrid fiber layers 12, 13. Here, the stable fiber is wound on the mandrel only at a position corresponding to the cylindrical portion 41. In the preferred embodiment, while dynamic fiber is helically wound on the mandrel, the hoop winding 12 is stacked. Then, the hoop winding 12 and the axial winding 13 are alternately stacked on the mandrel.

Once the first hybrid fiber layer 11 and the second hybrid fiber layers 12, 13 are completely formed, the epoxy resin is cured thereby complete the manufacturing processes.

FIG. 4 is a sectional view of the pressure vessel, which shows that the forward dome and the aft dome have collapsed by abnormal combustion of the propellants.

When an external temperature of the body 10 increases due to external fire, etc., the temperature of the propellants 18 inside the body 10 increases to a temperature more than the ignition temperature as time lapses. Accordingly, the propellants 18 are ignited thus to be abnormally combusted.

When the external temperature increases to the highest storage temperature of the propellants 18 (e.g., 80°) before the temperature of the propellants 18 increases to the ignition temperature, the dynamic fiber of the first hybrid fiber layer 11 has a lowered mechanical property.

As the external temperature continuously increases, the mechanical property of the first hybrid fiber layer 11 is drastically lowered. Then, when the external temperature reaches a temperature close to the ignition temperature of the propellants (e.g., 145°), the dynamic fiber starts to melt.

Accordingly, before the external temperature increases up to the ignition temperature of the propellants 18, the forward dome 42 and the aft dome 43 lose their roles as supporting members.

Once the inner temperature of the body 10 increases up to the ignition temperature of the propellants 18, the propellants 18 are ignited to be combusted. Reference numeral 21 indicates flame occurring as the propellants 18 are combusted.

As the propellants 18 are combusted, a pressure inside the body 10 increases, and thus the forward dome 42 and the aft dome 43 collapse at a comparatively low pressure.

Combustion gas of the propellants 18 is exhausted out of the body 10 through the collapsed parts of the body 10. Accordingly, the pressure inside the body 10 is prevented from increasing, and thus explosion of the body 10 is prevented.

The temperature where the mechanical property of the dynamic fiber starts to be lowered is much lower than the ignition temperature of the propellants 18. More concretely, the mechanical property of the dynamic fiber starts to be lowered at a temperature lower than the ignition temperature of the propellants 18 by at least 50°. This structure is implemented so as to collapse the forward dome 42 and the aft dome 43 before a pressure difference between the inside and the outside of the body 10 becomes large.

In the present invention, the forward dome and the aft dome are made to collapse at a comparatively low temperature by having the mechanical property at a temperature more than the highest storage temperature of the propellants 18. Accordingly, combustion gas and flame inside the pressure vessel are exhausted out of the body through the collapsed parts of the forward dome and the aft dome. Accordingly, explosion of the pressure vessel is prevented.

As aforementioned, in the present invention, the mechanical property of the forward dome and the aft dome starts to be lowered at a temperature more than a specific temperature, so that the forward dome and the aft dome collapse at a comparatively low pressure. Accordingly, combustion gas and flame inside the pressure vessel are exhausted out through the collapsed parts of the forward dome and the aft dome. Accordingly, explosion of the pressure vessel is prevented.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A pressure vessel for propellants, comprising:
a body provided with a cylindrical portion between a forward dome and an aft dome, and having an inner space where propellants are arranged;
an insulation layer disposed on an inner wall of the body, and configured to insulate the body from the inner space when the propellants are ignited; and
a nozzle mounted at the aft dome, and through which combustion material from the propellants is exhausted out,
wherein the body comprises:
a first hybrid fiber layer which forms the cylindrical portion, the forward dome, and the aft dome, and having a mechanical property lowered at a temperature more than a specific temperature such that the forward dome and the aft dome collapse by an inner pressure when the propellants are abnormally combusted; and
a second hybrid fiber layer which forms at least a part of the cylindrical portion, and maintaining its mechanical property when the propellants are abnormally combusted.

2. The pressure vessel for propellants of claim 1, wherein:
the first hybrid fiber layer is formed by mixing dynamic fiber and epoxy resin with each other; and
wherein the dynamic fiber has a mechanical property lower than that at room temperature, in the range from a temperature more than a highest storage temperature of the propellants to a temperature lower than an ignition temperature.

3. The pressure vessel for propellants of claim 2, wherein:
the dynamic fiber is configured such that the body has a collapse pressure value less than 70% of a collapse pressure value at room temperature, at a temperature more than the highest storage temperature of the propellants.

4. The pressure vessel for propellants of claim 2, wherein:
the dynamic fiber is formed of a material which melts at a temperature lower than the ignition temperature of the propellants.

5. The pressure vessel for propellants of claim 2, wherein:
the dynamic fiber is provided with a chemical structure of polyolefin having a uni-directional structure.

6. The pressure vessel for propellants of claim 5, wherein:
the dynamic fiber is polyethylene.

7. The pressure vessel for propellants of claim 2, wherein:
the first hybrid fiber layer is formed by helically winding dynamic fiber impregnated with epoxy resin from the forward dome to the aft dome via the cylindrical portion.

8. The pressure vessel for propellants of claim 1, wherein:
the second hybrid fiber layer is formed by mixing stable fiber and epoxy resin with each other; and
at a temperature more than the ignition temperature of the propellants, the stable fiber has a mechanical property equal to that at room temperature.

9. The pressure vessel for propellants of claim 8, wherein:
the stable fiber is formed of one of carbon, aramid, glass, and metal.

10. The pressure vessel for propellants of claim 8, wherein the second hybrid fiber layer comprises:
a hoop winding formed as stable fiber impregnated with epoxy resin is wound in a circumferential direction of the body; and
an axial winding formed as stable fiber impregnated with epoxy resin is wound in an axial direction of the body.

11. A method for preventing explosion of a pressure vessel for propellants that comprises a body provided with a cylindrical portion between a forward dome and an aft dome, propellants arranged at an inner space of the body, an insulation layer disposed on an inner wall of the body and configured to insulate the body from the inner space when the propellants are ignited, and a nozzle mounted at the aft dome and through which combustion material from the propellants is exhausted out, the method comprising:
lowering mechanical properties of the forward dome and the aft dome by an external temperature of the body such that the propellants are abnormally combusted, the external temperature increased to a temperature more than a predetermined temperature; and
collapsing the forward dome and the aft dome according to increase of an inner pressure of the body due to the combustion of the propellants.

12. A method for manufacturing a pressure vessel for propellants, the pressure vessel having a cylindrical portion between a forward dome and an aft dome, the method comprising:
forming the forward dome, the cylindrical portion, and the aft dome by winding dynamic fiber impregnated with epoxy resin;
forming a part of the cylindrical portion by winding stable fiber impregnated with epoxy resin while the dynamic fiber is being wound or after the dynamic fiber has been wound; and
curing the epoxy resin,
wherein the dynamic fiber has a mechanical property lower than at room temperature, in the range from a temperature more than a highest storage temperature of the propellants to a temperature lower than an ignition temperature, and
wherein at a temperature more than the ignition temperature of the propellants, the stable fiber has a mechanical property equal to that at room temperature.

13. The method of claim 12, wherein:
the dynamic fiber is provided with a chemical structure of polyolefin having a uni-directional structure.

14. The method of claim 12, wherein:
the dynamic fiber is helically wound from the forward dome to the aft dome via the cylindrical portion.

15. The method of claim 12, wherein:
the stable fiber is formed of one of carbon, aramid, glass, and metal.

16. The method of claim 12, wherein:
some parts of the stable fiber is hoop-wound in a circumferential direction of the body, and other parts thereof is axially wound in an axial direction of the body.
